(19) United States
(12) Patent Application Publication
(10) Pub. No.: US 2018/0030269 A1
(43) Pub. Date: Feb. 1, 2018

(54) SELF-HEALING POLYMER FORMULATIONS, COATING FILM, LAMINATE, AND ELECTRONIC DEVICE

(71) Applicant: SAMSUNG ELECTRONICS CO., LTD., Suwon-si (KR)

(72) Inventors: Myung Man KIM, Suwon-si (KR); Nobuji SAKAI, Kanagawa-ken (JP); Chung Kun CHO, Suwon-si (KR); Mikhail KOVALEV, Suwon-si (KR)

(21) Appl. No.: 15/398,895

(22) Filed: Jan. 5, 2017

(30) Foreign Application Priority Data
Jul. 29, 2016 (KR) 10-2016-0097037

(51) Int. Cl. C08L 75/16; C08J 7/04

(52) U.S. Cl. CPC C08L 75/16; C08J 7/047; C08J 2375/16

(57) ABSTRACT

A self-healing polymer formulation includes a polyurethane (meth)acrylate, a siloxane (meth)acrylate, a nanoparticle, and a hardener, a polymer film includes a cured product of the polymer formulation, and an electronic device includes the same.

### CROSS-REFERENCE TO RELATED APPLICATION

This application claims priority to and the benefit of Korean Patent Application No. 10-2016-0097037 filed in the Korean Intellectual Property Office on Jul. 29, 2016, and all of the benefits accruing therefrom under 35 U.S.C. § 119, the content of which is incorporated herein in its entirety by reference.

### BACKGROUND

### 1. Field

A self-healing polymer formulation, a coating film, a laminate, and an electronic device are disclosed.

### 2. Description of the Related Art

A thin and lightweight display material for use in a portable electronic device such as a smart phone or a tablet PC is increasingly in demand. A tempered glass having satisfactory mechanical characteristics has been applied on the front screen of portable electronic devices to protect the portable electronic device. However, the tempered glass is often heavy and easily broken by an external impact, and is thus limiting in some aspects. Alternatively, a hard coating film may be applied to the front screen of a device, but it may be difficult to restore the coating to its original state once it has been damaged.

Thus, there remains a need for a new polymer formulation having improved properties.

### SUMMARY

An embodiment provides a self-healing polymer formulation that reduces the generation of scratches and promotes the self-healing of scratches.

Another embodiment provides a polymer film including the self-healing polymer formulation.

Yet another embodiment provides a laminate including the polymer film.

Still another embodiment provides an electronic device including the polymer film or the laminate.

According to an embodiment, a self-healing polymer formulation includes a polyurethane (meth)acrylate, a siloxane (meth)acrylate, a nanoparticle, and a hardener.

The siloxane (meth)acrylate may be a reaction product of a siloxane compound represented by Chemical Formula 1 and a (meth)acrylate compound.

(R¹R²R³SiO_{1/2})_{M}(R⁴R⁵SiO_{2/2})_{D}(R⁶SiO_{3/2})_{T}(SiO_{4/2})_{Q} Chemical Formula 1

In Chemical Formula 1,

R¹ to R⁶ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof,

0≦M<1, 0≦D<1, 0≦T<1, and 0≦Q<1, and

M+D+T+Q=1.

The siloxane compound may be represented by Chemical Formula 1a.

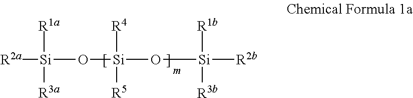

In Chemical Formula 1a,

R^{1a}, R^{2a}, R^{3a}, R^{1b}, R^{2b}, R^{3b}, R⁴, and R⁵ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof, and

0≦m<1000.

The siloxane compound may be included in an amount of less than or equal to about 50 weight percent based on the total amount of the siloxane compound and the (meth)acrylate compound.

The siloxane compound and the (meth)acrylate compound may be included in a weight ratio of about 20:80 to about 50:50.

The (meth)acrylate compound may include an alkyl(meth)acrylate, a hydroxylalkyl(meth)acrylate, a ((meth)acryloyloxy)alkyl isocyanate, a homopolymer thereof, a copolymer thereof, or a combination thereof.

The (meth)acrylate-containing compound may include a homopolymer or a copolymer of methyl(meth)acrylate, hydroxylethyl(meth)acrylate, and 2-((meth)acryloyloxy)ethyl isocyanate.

A weight average molecular weight of the polyurethane (meth)acrylate may range from about 2,000 to about 10,000 grams per mole.

The self-healing polymer formulation may further include a solvent, and the siloxane (meth)acrylate may be included in an amount of about 0.1 weight percent to about 5 weight percent based on a total solids weight of the self-healing polymer formulation.

The self-healing polymer formulation may further include a solvent, and the nanoparticle may be included in an amount of greater than or equal to about 1 weight percent and less than about 5 weight percent based on a total solids weight of the self-healing polymer formulation.

According to another embodiment, a polymer film includes a cured product of the self-healing polymer formulation.

The polymer film may include a contact angle of greater than or equal to about 81 degrees and a pencil hardness of 2H or greater as measured with a 1 kilogram load.

The polymer film may include a pencil hardness of 2H or greater as measured with a 1 kilogram load and a self-healing time of less than or equal to about 10 seconds.

The polymer film may comprise a light transmittance of greater than or equal to about 90%, a yellow index of less than about 1, and a haze value of less than about 1.

A siloxane moiety derived from the siloxane (meth)acrylate may be present at a surface of the polymer film.

According to another embodiment, a laminate includes a polymer substrate and a polymer film disposed on a surface of the polymer substrate, wherein the polymer film includes an internal layer including a polyurethane having a cross-linking structure and a nanoparticle, and a surface layer including a siloxane moiety.

The polymer film may include a pencil hardness of 2H or greater as measured with a 1 kilogram load and a self-healing time of less than or equal to about 10 seconds.

The polymer film may include a light transmittance of greater than or equal to about 90%, a yellow index of less than about 1, and a haze value of less than about 1.

According to another embodiment, an electronic device includes the polymer film.

According to another embodiment, an electronic device includes the laminate.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a graph of absorbance (arbitrary units, au) versus wavenumber (inverse centimeters, cm⁻¹) and shows Fourier Transform Infrared (FT-IR) spectra of a siloxane moiety along a thickness direction of the polymer films according to Examples 1 to 3;

FIG. 2 is a graph of absorbance (au) versus wavenumber (cm⁻¹) and shows FT-IR spectra of a siloxane moiety along a thickness direction of the polymer films according to Examples 4 to 6;

FIG. 3 is a graph of absorbance (au) versus wavenumber (cm⁻¹) and shows FT-IR spectra of a siloxane moiety along a thickness direction of the polymer films according to Examples 7 to 9;

FIG. 4 is a graph of absorbance (au) versus wavenumber (cm⁻¹) and shows FT-IR spectra of a siloxane moiety along a thickness direction of the polymer films according to Examples 10 and 11;

FIG. 5 is a graph of absorbance (au) versus wavenumber (cm⁻¹) and shows an FT-IR spectrum of a polyurethane acrylate of Synthesis Example 1;

FIG. 6 is a graph of intensity (au) versus time (minutes) showing a gel permeation chromatography result for the polyurethane acrylate of Synthesis Example 1; and

FIG. 7 is a cross-sectional view showing a laminate according to an embodiment.

### DETAILED DESCRIPTION

Exemplary embodiments will hereinafter be described in detail, and may be easily realized by those who have common knowledge in the related art. However, this disclosure may be embodied in many different forms and is not to be construed as limited to the exemplary embodiments set forth herein.

Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of” when preceding a list of elements, modify the entire list of elements and do not modify the individual elements of the list.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, when a definition is not otherwise provided, the term “substituted” refers to a group or compound wherein at least one of the hydrogen atoms thereof is substituted with a halogen atom (F, Cl, Br, or I), a hydroxy group, a nitro group, a cyano group, an amino group, an azido group, an amidino group, a hydrazino group, a hydrazono group, a carbonyl group, a carbamoyl group, a thiol group, an ester group, a carboxylic acid group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, and a combination thereof.

As used herein, when a definition is not otherwise provided, the term “hetero” refers to a compound or group including 1 to 4 heteroatoms selected from N, O, S, Se, Te, Si, and P.

As used herein, when a definition is not otherwise provided, the term “alkyl” group refers to a straight or branched chain saturated aliphatic hydrocarbon having the specified number of carbon atoms, and having a valence of at least one, optionally substituted with one or more substituents where indicated, provided that the valence of the alkyl group is not exceeded.

As used herein, when a definition is not otherwise provided, the term “alkenyl” group refers to a straight or branched chain hydrocarbon that comprises at least one carbon-carbon double bond, having the specified number of carbon atoms, and having a valence of at least one, optionally substituted with one or more substituents where indicated, provided that the valence of the alkenyl group is not exceeded.

As used herein, when a definition is not otherwise provided, the term “alkynyl” group refers to a straight or branched chain, monovalent hydrocarbon group having at least one carbon-carbon triple bond, having the specified number of carbon atoms, and having a valence of at least one, optionally substituted with one or more substituents where indicated, provided that the valence of the alkynyl group is not exceeded.

As used herein, when a definition is not otherwise provided, the alkyl group, the alkenyl group, or the alkynyl group may be linear or branched. Examples of the alkyl group may be a methyl group, an ethyl group, an iso-propyl group, a tert-butyl group, a n-octyl group, a n-decyl group, a n-hexadecyl group, and the like. Examples of the alkenyl group may be a vinyl group, an allyl group, a 2-butenyl group, or 3-pentenyl group. Examples of the alkynyl group may be a propargyl group, or a 3-pentynyl group.

As used herein, when a definition is not otherwise provided, the term “cycloalkyl” group refers to a group that comprises one or more saturated and/or partially saturated rings in which all ring members are carbon, such as cyclopropyl, cyclobutyl, cyclopentyl, cyclohexyl, cycloheptyl, cyclooctyl, adamantyl and partially saturated variants of the foregoing, such as cycloalkenyl groups (e.g., cyclohexenyl) or cycloalkynyl groups, and having a valence of at least one, and optionally substituted with one or more substituents where indicated, provided that the valence of the alkyl group is not exceeded.

As used herein, when a definition is not otherwise provided, the term “aryl” group refers to a cyclic group in which all ring members are carbon and at least one ring is aromatic, the group having the specified number of carbon atoms, for example a C6 to C30 aryl group, and specifically a C6 to C18 aryl group, and having a valence of at least one, optionally substituted with one or more substituents where indicated, provided that the valence of the aryl group is not exceeded. More than one ring may be present, and any additional rings may be independently aromatic, saturated or partially unsaturated, and may be fused, pendant, spirocyclic, or a combination thereof.

As used herein, when a definition is not otherwise provided, the term “amino group” refers to —NRR′ wherein R and R′ are independently hydrogen, a C1 to C20 alkyl group, or a C6 to C30 aryl group.

As used herein, when a definition is not otherwise provided, the term “siloxane” refers to a compound or polymer and a divalent radical of the formula —[Si(R)(R′)O]— wherein R and R′ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted 01 to C30 alkoxy group, or a hydroxy group.

As used herein, when a definition is not otherwise provided, the term “(meth)acryl” refers to acryl and/or methacryl, the term “(meth)acryloyloxy” refers to acryloyloxy and/or methacryloyloxy, and the term “(meth)acryloylamino” refers to acryloylamino and/or methacryloylamino.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1 to C20 alkyl” refers to a C1 to C20 alkyl group substituted with a C6 to C20 aryl group, the total number of carbon atoms in the resulting aryl substituted alkyl group is C7 to C40.

As used herein, Mn is number average molecular weight.

As used herein, the term ‘combination’ refers to a mixture of two or more and a laminate of two or more.

Hereinafter, a self-healing polymer formulation according to an embodiment is described.

A self-healing polymer formulation according to an embodiment includes a polyurethane (meth)acrylate, a siloxane (meth)acrylate, a nanoparticle, a hardener, and a solvent.

The polyurethane (meth)acrylate may be a polymer having a urethane bond and (meth)acrylate at the terminal end. The polyurethane (meth)acrylate may be synthesized in various known methods, and for example, in a method of obtaining polyurethane from an alcohol compound having a hydroxy group, such as a polyol, and an isocyanate compound having an isocyanate group, and then using the polyurethane with a (meth)acrylate compound.

Without being limited by theory, the polyurethane (meth)acrylate is cured and forms a cross-linking structure and thus has high elasticity, and resultantly, may prevent or reduce a surface scratch by an external stress and be self-healed from a surface scratch through a strong hydrogen bonding force at room temperature after a short time.

A weight average molecular weight (Mw) of the polyurethane (meth)acrylate may range from about 2,000 grams per mole (g/mol) to about 10,000 g/mol, for example about 2,500 g/mol to about 8,000 g/mol. When the polyurethane (meth)acrylate has a weight average molecular weight within the range, a strong coating having a high surface hardness may be obtained.

Polydispersity (Mw/Mn) of the polyurethane (meth)acrylate may be about 0.8 to about 1.2, for example about 0.9 to about 1.1.

The polyurethane (meth)acrylate may be included in an amount of about 80 weight percent (wt %) to about 98 wt %, for example about 85 wt % to about 95 wt %, based on the total weight of the polymer formulation. Herein, the total weight refers to a total weight of the solids excluding a solvent.

The siloxane (meth)acrylate may be a reaction product of a siloxane compound and a (meth)acrylate compound. For example, the siloxane (meth)acrylate may be obtained by polymerization of the siloxane compound and the (meth)acrylate compound in a solvent.

The siloxane compound is a compound including a Si—O—Si bond, and may be, for example, represented by Chemical Formula 1.

(R¹R²R³SiO_{1/2})_{M}(R⁴R⁵SiO_{2/2})_{D}(R⁶SiO_{3/2})_{T}(SiO_{4/2})_{Q} Chemical Formula 1

In Chemical Formula 1,

R¹ to R⁶ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof,

0≦M<1, 0≦D<1, 0≦T<1, and 0≦Q<1, and

M+D+T+Q=1.

The siloxane compound may have various structures, for example a chain structure or a reticular structure, such as a crosslinked, cage, or graft structure.

The siloxane compound may be, for example, a siloxane compound having a chain structure, and may be, for example, represented by Chemical Formula 1a.

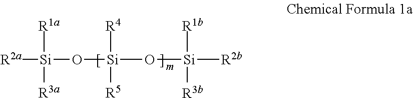

In Chemical Formula 1a,

R^{1a}, R^{2a}, R^{3a}, R^{1b}, R^{2b}, R^{3b}, R⁴, and R⁵ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof, and

0≦m<1000.

The siloxane compound may be, for example, a compound including an azo reaction initiator.

The (meth)acrylate compound may be a monomer, an oligomer, and/or a polymer having a (meth)acrylate group. The (meth)acrylate compound may be, for example, an alkyl(meth)acrylate, a hydroxylalkyl(meth)acrylate, a ((meth)acryloyloxy)alkyl isocyanate, a homopolymer thereof, a copolymer thereof, or a combination thereof, but is not limited thereto. Herein, alkyl refers to a C1 to C30 linear or branch alkyl, for example a C1 to C10 linear or branch alkyl.

The (meth)acrylate compound may include, for example, a homopolymer or a copolymer of methyl(meth)acrylate, hydroxylethyl(meth)acrylate, and 2-((meth)acryloyloxy)ethyl isocyanate.

The (meth)acrylate compound may be, for example, a copolymer of methyl(meth)acrylate, hydroxylethyl(meth)acrylate, and 2-((meth)acryloyloxy)ethyl isocyanate, but is not limited thereto.

The (meth)acrylate compound may be, for example, a copolymer of methyl(meth)acrylate, hydroxylethyl(meth)acrylate, and 2-((meth)acryloyloxy)ethyl isocyanate, which may be, for example, obtained by copolymerizing methyl(meth)acrylate and hydroxylethyl(meth)acrylate and then performing a grafting reaction of 2-((meth)acryloyloxy)ethyl isocyanate. Herein, hydroxylethyl(meth)acrylate and 2-((meth)acryloyloxy)ethyl isocyanate may each be included in an amount of about 5 wt % to about 15 wt %.

The siloxane compound may be included in an amount of less than or equal to about 50 wt % based on the total weight of the siloxane compound and the (meth)acrylate compound. When the siloxane compound is included within the range, transparent siloxane (meth)acrylate may be obtained, which can be cured and effectively manufactured into a transparent film.

The siloxane compound and the (meth)acrylate compound may be included in a weight ratio of about 20:80 to about 50:50. When the siloxane compound and the (meth)acrylate compound are included within the ratio, a high transparency and a desirable surface hardness may be effectively secured.

The siloxane compound and the (meth)acrylate compound may be, for example, selectively polymerized with a reaction initiator in a solvent such as toluene at a temperature of about 50° C. to about 100° C.

The siloxane (meth)acrylate may have a weight average molecular weight (Mw) ranging from about 50,000 to about 400,000, for example, from about 100,000 to about 300,000, when measured by using gel permeation chromatography (GPC).

The siloxane (meth)acrylate may have, for example, a polydispersity (Mw/Mn) ranging from about 1.5 to about 4.0, for example, about 1.8 to about 3.0.

The siloxane (meth)acrylate may be included in an amount of about 0.1 wt % to about 10 wt % based on the total weight of the self-healing polymer formulation. Within the range, the siloxane (meth)acrylate may be included in an amount of about 0.1 wt % to about 5 wt %. Herein, the content is based on the total weight of the solids excluding a solvent.

A nanoparticle may have a nano-level diameter, for example, a diameter ranging from about 1 nanometer (nm) to hundreds of nanometers, and for example, a diameter ranging from about 1 nm to about 100 nm.

The nanoparticle may be, for example, an inorganic nanoparticle, an organic nanoparticle, or an organic/inorganic nanoparticle, for example silica, alumina, titanium oxide, and the like, but is not limited thereto.

The nanoparticle is disposed in a polymer and thus may harden a coating film and enhance its surface hardness.

The nanoparticle may be included in an amount of about 0.1 wt % to about 7 wt % based on the total weight of the self-healing polymer formulation. Within the range, the nanoparticle may be included in an amount of about 1 wt % to about 5 wt %. When the nanoparticle is included within the range, a thin film simultaneously having appropriate surface hardness and transparency may be obtained. Herein, the content may be based on the total weight of solids excluding a solvent.

A hardener may be, for example, a photoinitiator, for example a free radical photoinitiator and/or an ionic photoinitiator. The hardener may be, for example, benzophenone, a ketone-based initiator, benzoic acid, anthraquinone, acylphosphine, and the like, but is not limited thereto.

The hardener may be included in an amount of about 0.01 wt % to about 10 wt % based on the total weight of the self-healing polymer formulation. Within the range, the hardener may be included in an amount of about 0.1 wt % to about 5 wt %.

The solvent may have no particular limit as long as it may dissolve or disperse the aforementioned components, but may include, for example, at least one selected from an aliphatic hydrocarbon solvent such as hexanes, heptane, methylene chloride, and the like; an aromatic hydrocarbon solvent such as benzene, toluene, pyridine, quinoline, anisole, mesitylene, xylene, and the like; a ketone-based solvent such as methyl isobutyl ketone, 1-methyl-2-pyrrolidinone (NMP), cyclohexanone, acetone, and the like; an ether-based solvent such as tetrahydrofuran (THF), isopropyl ether, and the like; an acetate-based solvent such as ethyl acetate, butyl acetate, propylene glycol methyl ether acetate, and the like; an alcohol-based solvent such as isopropyl alcohol, butanol, and the like; an amide-based solvent such as dimethylacetamide, dimethylformamide (DMF), and the like; a nitrile-based solvent such as acetonitrile, benzonitrile, and the like; and a mixture of the solvents, but is not limited thereto.

The polyurethane (meth)acrylate, the siloxane (meth)acrylate, the nanoparticle, the hardener, and the solvent may be mixed and prepared into a self-healing polymer formulation in a solution state.

The polymer formulation may be coated on a substrate and cured and thus formed into a polymer film. The substrate may be formed of a transparent polymer, for example, a polyethylene terephthalate, a polycarbonate, a polyimide, and/or polyamide, but is not limited thereto. The polymer film may be in a form in which the nanoparticle is dispersed in a cured product of the polyurethane (meth)acrylate and the siloxane (meth)acrylate, and a siloxane moiety derived from the siloxane (meth)acrylate may migrate towards the surface of the polymer film and be present at the surface of the polymer film. Accordingly, the polymer film may include an internal layer including a polyurethane having a cross-linking structure, and the nanoparticle and a surface layer including the siloxane moiety.

The polymer film may have, for example, a contact angle ranging from greater than or equal to about 81 degrees, for example greater than or equal to about 81 degrees within the range, greater than or equal to about 83 degrees, greater than or equal to about 85 degrees, greater than or equal to about 86 degrees, greater than or equal to about 88 degrees, or greater than or equal to about 90 degrees. Herein, the contact angle may be measured according to a Sessile drop technique. The contact angle may be measured by depositing a liquid such as water, diiodomethane, and the like in a predetermined amount (about 15 ml) on the polymer film and using equipment such as a Drop Shape Analyzer (DSA100, KRUSS, Germany).

The polymer film may have a pencil hardness of, for example, greater than or equal to 2H, for example greater than or equal to 3H, or greater than or equal to 4H. Herein, the pencil hardness may be measured according to ASTM D3363 with a load of 1 kg.

The polymer film may have, for example, a self-healing time of less than or equal to about 10 seconds (s) at room temperature, for example less than or equal to about 9 s within the range, less than or equal to about 8 s, or less than or equal to about 7 s. Herein, the self-healing time may be time taken until a scratch is healed after causing the scratch on the polymer film with a pencil having an appropriate hardness (9B to 9H).

The polymer film may, for example, have a light transmittance of greater than or equal to about 90%, a yellow index of less than about 1, and a haze value of less than about 1.

Without being bound by theory, the polymer film is highly elastic and dense due to a cross-linking structure and thus may prevent or reduce a surface scratch caused by an external stress and self-heal a surface scratch by a strong hydrogen bonding force at room temperature within a short amount of time. In addition, the siloxane moiety on the surface of the polymer film may decrease a surface friction coefficient and reinforce the slip characteristics of the polymer film, and accordingly reduce or prevent the surface from becoming scratched. Accordingly, the polymer film may have an effect of decreasing the surface friction coefficient and thus reducing or preventing the surface scratch and simultaneously self-healing the surface scratch without cutting a polymer chain, and thus may be used to prevent damage caused by an external stress. Particularly, the polymer film may be applied to a flexible display device such as a foldable display device or a bendable display device, and thus may effectively prevent the damage caused by an external stress.

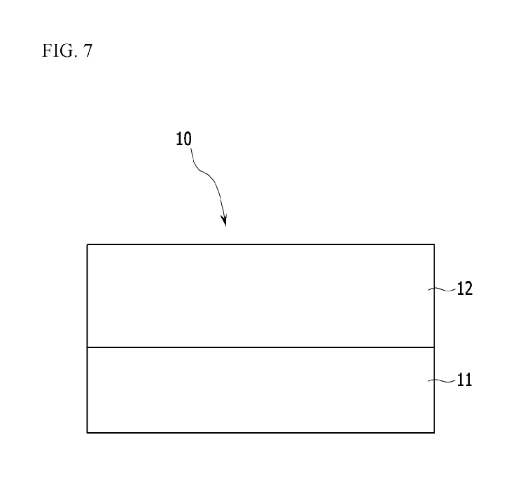

FIG. 7 is a cross-sectional view showing a laminate according to an embodiment.

Referring to FIG. 7, the laminate 10 according to an embodiment includes a substrate 11 and a polymer film 12.

The substrate 11 may be formed of a transparent polymer, for example, a polyethylene terephthalate, a polycarbonate, a polyimide, and/or a polyamide, but is not limited thereto.

The polymer film 12 may be the same as described above, and the siloxane moiety derived from the siloxane (meth)acrylate moves toward the surface of the polymer film 12 due to low surface energy and may be mainly present at the surface of the polymer film 12.

The polymer film may be applied to various display devices. The polymer film may be attached as the aforementioned laminate form on a display panel. Herein, the display panel and the laminate may be bonded directly or through an adhesive. Alternatively, the polymer film may be applied in a solution form or a film form on a display panel equipped with a window. The display panel may be, for example, a liquid crystal display panel or an organic light emitting display panel, but is not limited thereto. The polymer film may be disposed at a side of a viewer.

The polymer film or a laminate including the polymer film may be applied to various electronic devices, for example, a smart phone, a tablet PC, a camera, a touch screen panel, and the like, but is not limited thereto.

Hereinafter, the present disclosure is illustrated in more detail with reference to examples. However, these examples are exemplary, and the present disclosure is not limited thereto.

### EXAMPLES

### Synthesis Example of Polyurethane (meth)acrylate

### Synthesis Example 1

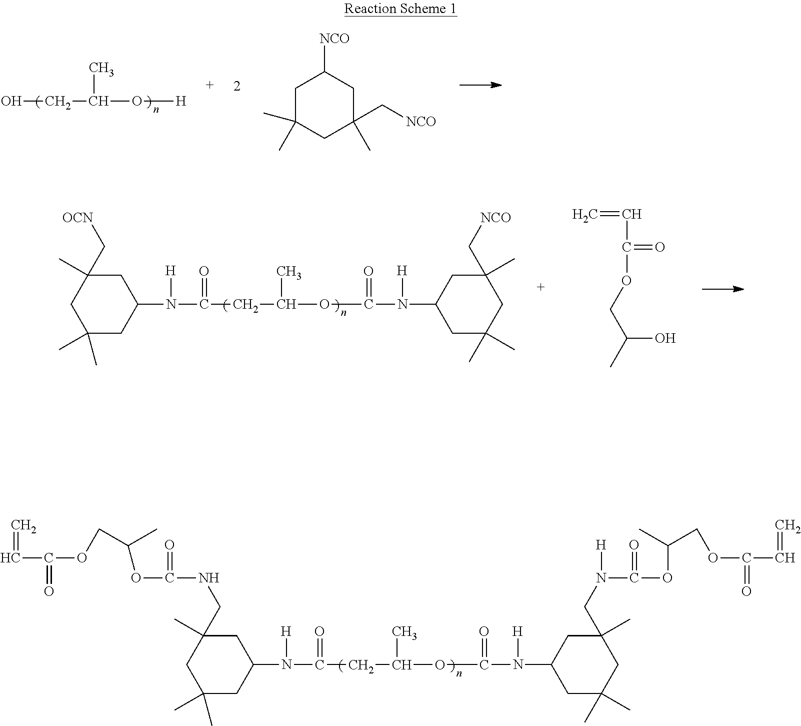

Polypropylene glycol and isophorene diisocyanate in an equivalent ratio of 1:2 or 1:4 are put in a 200 milliliter (mL) reactor, and the reactor is heated to 70° C. After stirring the mixture for about 30 minutes (min) until the introduced monomers reach 70° C., 100 parts per million (ppm) of dibutyltindilaurylate as a catalyst is introduced thereinto. Subsequently, the reactor is stirred for 45 min to complete a polyurethane reaction. The reactor is cooled to 60° C., and hydroxypropyl acrylate is introduced into the synthesized polyurethane in an equivalent ratio of 1:2 or 1:4 for 3 hours (h) to synthesize polyurethane acrylate in the reactor for 3 h. The structure of the synthesized polyurethane acrylate is examined through Fourier Transform Infrared (FT-IR) spectroscopy to obtain a typical polyurethane characteristic peak.

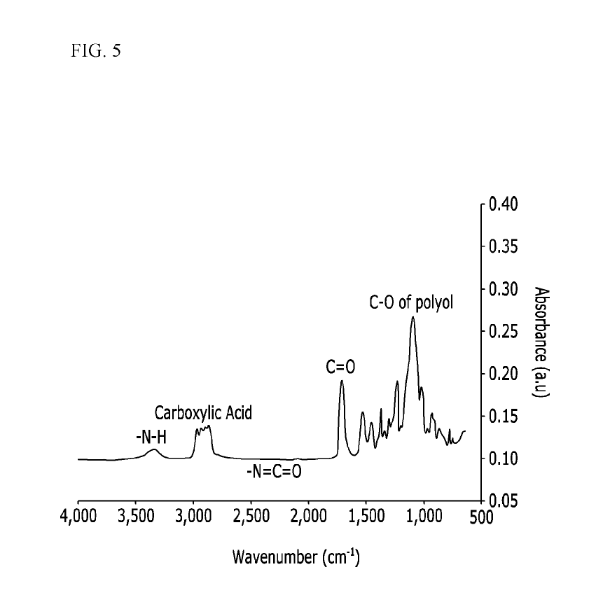

FIG. 5 is an FT-IR spectroscopy graph showing the polyurethane acrylate according to Synthesis Example 1.

Referring to FIG. 5, the synthesized polyurethane acrylate turns out to have a urethane bond since an isocyanate (wavenumber of 2350 cm⁻¹) functional group disappears.

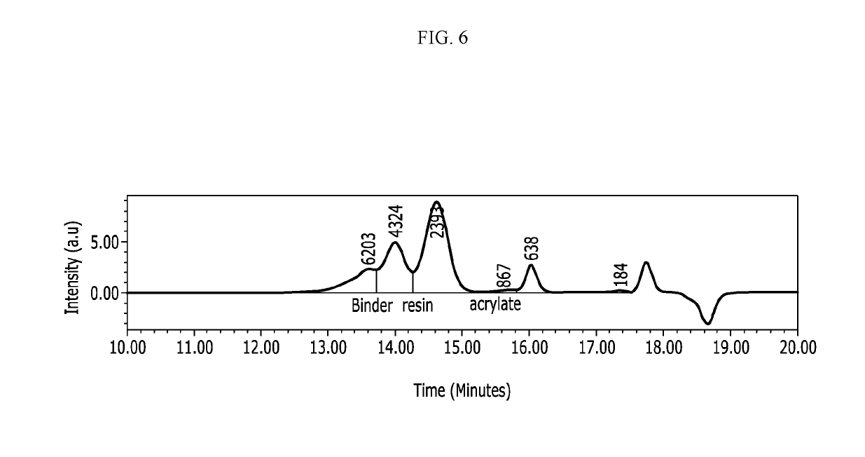

The weight average molecular weight of the synthesized polyurethane acrylate is measured through gel permeation chromatography (GPC), and the results are shown in FIG. 6 and Table 1.

FIG. 6 is a graph showing the gel permeation chromatography result of the polyurethane acrylate according to Synthesis Example 1.

In FIG. 6, three peaks from the left are from polyurethane acrylate, and the other two peaks are from acrylate and diisocyanate not participating in a reaction but remaining.

TABLE 1

| Peak Nos. | Mn | Mw | Mp | Mz | Polydispersity |
|---|---|---|---|---|---|
| 1 | 7226 | 7548 | 6203 | 7955 | 1.044644 |
| 2 | 4317 | 4390 | 4324 | 4464 | 1.016859 |
| 3 | 2375 | 2432 | 2393 | 2488 | 1.023895 |
| 4 | 951 | 970 | 867 | 992 | 1.020968 |
| 5 | 631 | 636 | 638 | 640 | 1.006997 |
| 6 | 183 | 184 | 184 | 184 | 1.003404 |

*Mn: number average molecular weight
*Mw: weight average molecular weight
* Mp: peak molecular weight
* Mz: Z-average molecular weight
* polydispersity = Mw/Mn

### Synthesis Example of Siloxane (meth)acrylate

### Synthesis Example 2

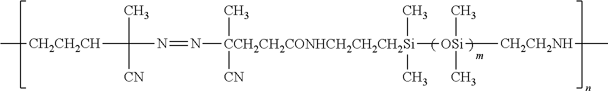

An azo-based initiator contained in a silicon-based polymer having the above structural unit (VPS-1001, Wako Pure Chemical, Japan) and 200 mL of methylmethacrylate in an equivalent ratio of 50:50 are put in a reactor, and toluene is supplied to obtain a solid content of 30%. Subsequently, the reactor is stirred at 80° C. for 5 h to synthesize a polydimethylsiloxane-methylmethacrylate (PDMS-MMA) copolymer.

### Synthesis Example 3

A polydimethylsiloxane-methylmethacrylate (PDMS-MMA) copolymer is synthesized according to the same method as Synthesis Example 2, except for using the azo-based initiator and the methylmethacrylate in an equivalent ratio of 20:80.

### Synthesis Example 4

A polydimethylsiloxane-methylmethacrylate-hydroxylethylacrylate (PDMS-MMA-HEA) copolymer is synthesized under the same reaction condition as Synthesis Example 2 by introducing the azo-based initiator, the methylmethacrylate, and hydroxylethylacrylate in an equivalent ratio of 20:70:10 and stirring them at 80° C. for 5 h.

When the reaction is complete, the reactor is cooled to 60° C., 2-(acryloyloxy)ethyl isocyanate (AOI, Showa Denko Chemicals, JAPAN) is introduced thereinto in a weight ratio of 10% based on the weight of a PDMS-MMA-HEA copolymer, and the mixture is reacted for 3 h to graft the 2-(acryloyloxy)ethyl isocyanate into the PDMS-MMA-HEA copolymer and synthesize a polydimethylsiloxane-methylmethacrylate-hydroxylethylacrylate-acryloyloxyethylisocyanate (PDMS-MMA-HEA-AOI) copolymer.

The reason for synthesizing a copolymer in this way is to induce the formation of a hydrogen bond by forming a urethane bond through a reaction between a hydroxyl group (OH—) in hydroxyethylacrylate and a cyanate group (NCO—) in isocyanate acrylate and to increase additional self-healing characteristics.

### Synthesis Example 5

A polydimethylsiloxane-methylmethacrylate-hydroxylethylacrylate-acryloyloxyethylisocyanate (PDMS-MMA-HEA-AOI) copolymer is synthesized according to the same method as Synthesis Example 4, except for using the azo-based initiator, the methylmethacrylate, and the hydroxylethylacrylate in an equivalent ratio of 50:40:10.

### EXAMPLES

### Example 1

89.7 weight percent (wt %) of the polyurethane acrylate according to Synthesis Example 1, 5 wt % of the siloxane methacrylate according to Synthesis Example 2, 5 wt % of silica (Aerosol R972, Cabot, Germany), and 0.3 wt % of a UV initiator (Irgacure184, Sigma-Aldrich) are put together and stirred to prepare a composition, and ethyl acetate is added thereto to adjust it to have a solids content of 70%.

Subsequently, the obtained product is doctor blade-coated on a 100 μm-thick PET substrate and dried, and then photocured with a light dose of 300 milliwatts per square centimeter (mW/cm²) for 2 min to form a 100 micrometer-thick (μm-thick) polymer film.

### Example 2

91.7 wt % of the polyurethane acrylate according to Synthesis Example 1, 3 wt % of the siloxane methacrylate according to Synthesis Example 2, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 3

93.7 wt % of the polyurethane acrylate according to Synthesis Example 1, 1 wt % of the siloxane methacrylate according to Synthesis Example 2, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 4

93.7 wt % of the polyurethane acrylate according to Synthesis Example 1, 1 wt % of the siloxane methacrylate according to Synthesis Example 3, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 5

91.7 wt % of the polyurethane acrylate according to Synthesis Example 1, 3 wt % of the siloxane methacrylate according to Synthesis Example 3, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 6

89.7 wt % of the polyurethane acrylate according to Synthesis Example 1, 5 wt % of the siloxane methacrylate according to Synthesis Example 3, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 7

93.7 wt % of the polyurethane acrylate according to Synthesis Example 1, 1 wt % of the siloxane methacrylate according to Synthesis Example 4, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 8

91.7 wt % of the polyurethane acrylate according to Synthesis Example 1, 3 wt % of the siloxane methacrylate according to Synthesis Example 4, 5 wt % of silica (Aerosol R972), and 0.3 wt % of a UV initiator (Irgacure184) are put together and stirred to prepare a composition, and ethyl acetate is added thereto to adjust it to have solids content of 70%.

Subsequently, a polymer film is formed on a PET substrate according to the same method as Example 1.

### Example 9

89.7 wt % of the polyurethane acrylate according to Synthesis Example 1, 5 wt % of the siloxane methacrylate according to Synthesis Example 4, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Example 10

91.7 wt % of the polyurethane acrylate according to Synthesis Example 1, 3 wt % of the siloxane methacrylate according to Synthesis Example 5, 5 wt % of silica (Aerosol R972), and 0.3 wt % of a UV initiator (Irgacure184) are put together and stirred to prepare a composition, and ethyl acetate is added thereto to adjust it to have a solid content of 70%.

Subsequently, a polymer film is formed on a PET substrate according to the same method as Example 1.

### Example 11

89.7 wt % of the polyurethane acrylate according to Synthesis Example 1, 5 wt % of the siloxane methacrylate according to Synthesis Example 5, 5 wt % of silica (Aerosol R972), and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Comparative Example 1

99.7 wt % of the polyurethane acrylate according to Synthesis Example 1 and 0.3 wt % of a UV initiator (Irgacure184) are put together and stirred to prepare a composition, and ethyl acetate is added thereto to adjust it to have a solids content of 70%.

Subsequently, a polymer film is formed on a PET substrate according to the same method as Example 1.

### Evaluation I

The polymer films of Examples 1 to 11 are examined to determine if a siloxane moiety is present on the surfaces through Fourier-transform Infrared (FT-IR) Spectroscopy.

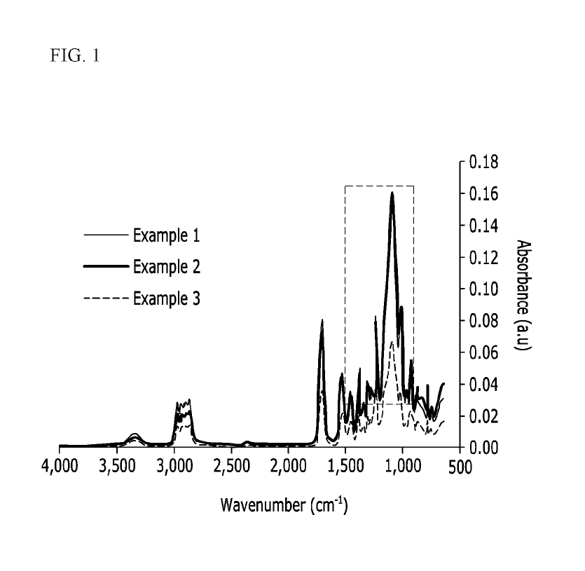

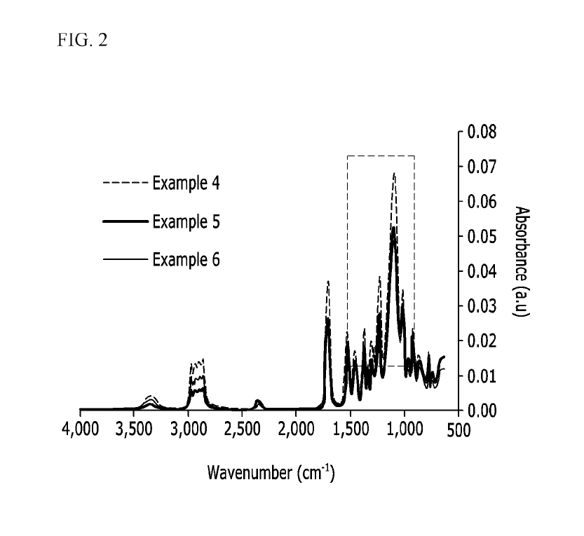

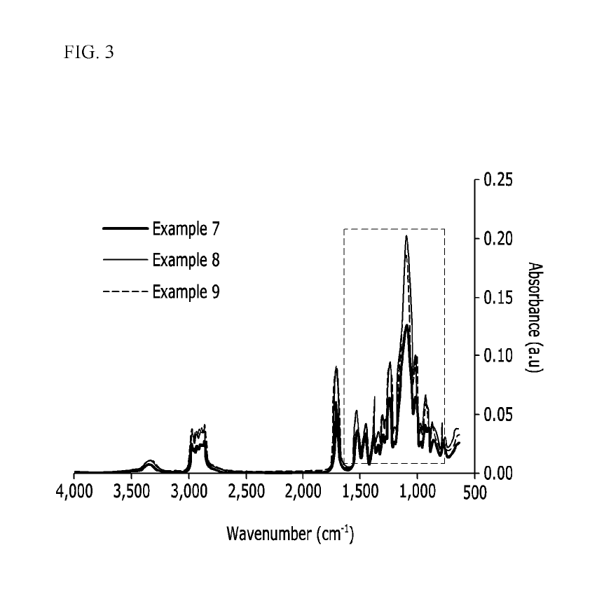

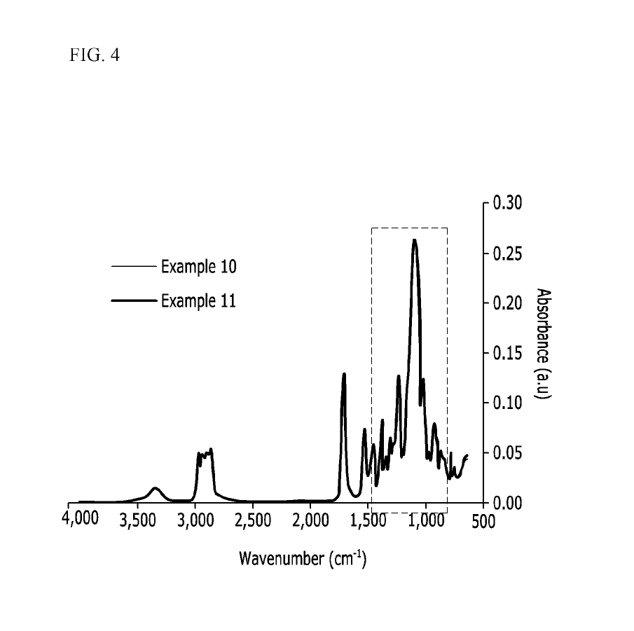

FIG. 1 is an FT-IR graph showing a distribution of a siloxane moiety along a thickness direction of the polymer films according to Examples 1 to 3, FIG. 2 is an FT-IR graph showing a distribution of a siloxane moiety along a thickness direction of the polymer films according to Examples 4 to 6, FIG. 3 is an FT-IR graph showing a distribution of a siloxane moiety along a thickness direction of the polymer films according to Examples 7 to 9, and FIG. 4 is an FT-IR graph showing a distribution of a siloxane moiety along a thickness direction of the polymer films according to Examples 10 and 11.

Referring to FIGS. 1 to 4, the siloxane moiety is distributed on the surfaces of the polymer films of Examples 1 to 11.

### Evaluation II

Light transmittance, haze, and yellow index of the polymer films of Examples 1 to 11 and Comparative Example 1 are evaluated.

The light transmittance, haze, and yellow index are measured with reference to ASTM E313 by using a UV spectrophotometer (cm-3600d, KONICA MINOLTA, Inc.).

The results are shown in Table 2.

TABLE 2

| | Light transmittance (%) | Haze | Yellow index |
|---|---|---|---|
| Example 1 | 90.35 | 0.35 | 0.57 |
| Example 2 | 92.10 | 0.44 | 0.25 |
| Example 3 | 90.06 | 0.22 | 0.39 |
| Example 4 | 90.49 | 0.12 | 0.31 |
| Example 5 | 90.26 | 0.22 | 0.35 |
| Example 6 | 90.49 | 0.32 | 0.43 |
| Example 7 | 90.43 | 0.13 | 0.37 |
| Example 8 | 90.05 | 0.87 | 0.37 |
| Example 9 | 90.10 | 0.46 | 0.36 |
| Example 10 | 90.36 | 0.27 | 0.40 |
| Example 11 | 90.32 | 0.67 | 0.30 |
| Comparative | 90.30 | 0.13 | 0.33 |
| Example 1 | | | |

Referring to Table 2, the polymer films of Examples 1 to 11 have a light transmittance of greater than or equal to about 90%, a yellow index of less than about 1, and a haze value of less than about 1, and have equivalent transparency to that of the polymer film of Comparative Example 1. Accordingly, the polymer films of Examples 1 to 11 demonstrate sufficient transparency and thus may be effectively applied to a screen of a display device.

### Evaluation III

A contact angle, surface hardness, and self-healing time of the polymer films of Examples 1 to 11 and Comparative Example 1 are evaluated.

The contact angle is evaluated using a Sessile drop technique, and specifically, is measured with a Drop Shape Analyzer (DSA100, KRUSS, Germany) after depositing water on the polymer films.

The surface hardness is evaluated by measuring the pencil scratch hardness with a pencil hardness meter (an automatic pencil scratch hardness tester No. 553-M1, YASUDA SEIKI SEISAKUSHO Ltd.) and a Mitsubishi pencil with reference to ASTM D3363. Specifically, the surface hardness is evaluated as the highest pencil hardness by fixing a PET substrate having a polymer film on a 2 millimeter thick (mm-thick) glass plate and moving a pencil 10 mm back and forth five times at 60 millimeters per minute (mm/min) with a vertical load of 1 kg.

The self-healing time is evaluated by time taken until a scratch is recovered after making the scratch on a coating film with appropriate hardness (9B to 9H).

The results are shown in Table 3.

TABLE 3

| | Contact angle | Pencil | Self-healing time |
|---|---|---|---|
| | (degrees) | hardness | (s, @ 25° C.) |
| Example 1 | 91.7 | 3H | <10 |
| Example 2 | 89.7 | 3H | <10 |
| Example 3 | 88.6 | 2H | <10 |
| Example 4 | 86.6 | 4H | <10 |
| Example 5 | 83.6 | 2H | <10 |
| Example 6 | 81.8 | 2H | <10 |
| Example 7 | 86.5 | 2H | <10 |
| Example 8 | 87.8 | 3H | <10 |
| Example 9 | 88.0 | 3H | <10 |
| Example 10 | 85.6 | 2H | <10 |
| Example 11 | 87.8 | 3H | <10 |
| Comparative | 80.5 | 1H | <10 |
| Example 1 | | | |

Referring to Table 3, the polymer films of Examples 1 to 11 turn out to have high contact angle and surface hardness and satisfactory self-healing time compared with the polymer film of Comparative Example 1, and specifically, simultaneously satisfy a contact angle of greater than or equal to about 81 degrees, pencil hardness of greater than or equal to about 2H, and a self-healing time of less than or equal to about 10 s. Accordingly, the polymer films of Examples 1 to 11 have reinforced slip characteristics and satisfactory self-healing, and thus may be expected to be effectively protected from a surface scratch by an external stress. While this disclosure has been described in connection with what is presently considered to be practical example embodiments, it is to be understood that the disclosure is not limited to the present embodiments, but, on the contrary, is intended to cover various modifications and equivalent arrangements included within the spirit and scope of the appended claims.

What is claimed is:

1. A self-healing polymer formulation, comprising
a polyurethane (meth)acrylate, a siloxane (meth)acrylate, a nanoparticle, and a hardener.

2. The self-healing polymer formulation of claim 1, wherein the siloxane (meth)acrylate is a reaction product of a siloxane compound represented by Chemical Formula 1 and a (meth)acrylate compound:
(R¹R²R³SiO_{1/2})_{M}(R⁴R⁵SiO_{2/2})_{D}(R⁶SiO_{3/2})_{T}(SiO_{4/2})_{Q} Chemical Formula 1
wherein, in Chemical Formula 1,
R¹ to R⁶ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof,
0≦M<1, 0≦D<1, 0≦T<1, and 0≦Q<1, and
M+D+T+Q=1.

3. The self-healing polymer formulation of claim 2, wherein the siloxane compound is represented by Chemical Formula 1a: 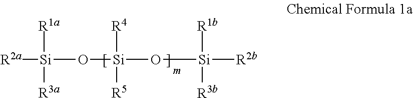
wherein, in Chemical Formula 1a,
R^{1a}, R^{2a}, R^{3a}, R^{1b}, R^{2b}, R^{3b}, R⁴, and R⁵ are independently hydrogen, a substituted or unsubstituted C1 to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, a substituted or unsubstituted C2 to C30 alkenyl group, a substituted or unsubstituted C1 to C30 alkoxy group, a hydroxy group, or a combination thereof, and
0≦m<1000.

4. The self-healing polymer formulation of claim 2, wherein the self-healing polymer formulation comprises the siloxane compound in an amount of less than or equal to about 50 weight percent based on a total amount of the siloxane compound and the (meth)acrylate compound.

5. The self-healing polymer formulation of claim 2, wherein the self-healing polymer formulation comprises the siloxane compound and the (meth)acrylate compound in a weight ratio of about 20:80 to about 50:50.

6. The self-healing polymer formulation of claim 2, wherein the (meth)acrylate compound comprises an alkyl(meth)acrylate, a hydroxylalkyl(meth)acrylate, a ((meth)acryloyloxy)alkyl isocyanate, a homopolymer thereof, a copolymer thereof, or a combination thereof.

7. The self-healing polymer formulation of claim 6, wherein the (meth)acrylate compound comprises a homopolymer or a copolymer of methyl(meth)acrylate, hydroxylethyl(meth)acrylate, and 2-((meth)acryloyloxy)ethyl isocyanate.

8. The self-healing polymer formulation of claim 1, wherein a weight average molecular weight of the polyurethane (meth)acrylate is about 2,000 to about 10,000 grams per mole.

9. The self-healing polymer formulation of claim 1, wherein the self-healing polymer formulation further comprises a solvent, and
comprises the siloxane (meth)acrylate in an amount of about 0.1 weight percent to about 5 weight percent based on a total solids weight of the self-healing polymer formulation.

10. The self-healing polymer formulation of claim 1, wherein the self-healing polymer formulation further comprises a solvent, and
comprises the nanoparticle in an amount of greater than or equal to about 1 weight percent and less than about 5 weight percent based on a total solids weight of the self-healing polymer formulation.

11. A polymer film comprising a cured product of the self-healing polymer formulation of claim 1.

12. The polymer film of claim 11, wherein the polymer film comprises a contact angle of greater than or equal to about 81 degrees and a pencil hardness of 2H or greater as measured with a 1 kilogram load.

13. The polymer film of claim 11, wherein the polymer film comprises a pencil hardness of 2H or greater as measured with a 1 kilogram load and a self-healing time of less than or equal to about 10 seconds.

14. The polymer film of claim 11, wherein the polymer film comprises a light transmittance of greater than or equal to about 90%, a yellow index of less than about 1, and a haze value of less than about 1.

15. The polymer film of claim 11, wherein a siloxane moiety derived from the siloxane (meth)acrylate is present at a surface of the polymer film.

16. A laminate comprising:
a polymer substrate; and
a polymer film disposed on a surface of the polymer substrate,
wherein the polymer film comprises
an internal layer comprising a polyurethane having a cross-linking structure and a nanoparticle, and
a surface layer comprising a siloxane moiety.

17. The laminate of claim 16, wherein the polymer film comprises a pencil hardness of 2H or greater as measured with a 1 kilogram load and a self-healing time of less than or equal to about 10 seconds.

18. The laminate of claim 16, wherein the polymer film comprises a light transmittance of greater than or equal to about 90%, a yellow index of less than about 1, and a haze value of less than about 1.

19. An electronic device comprising the polymer film of claim 11.

20. An electronic device comprising the laminate of claim 16.
